(19) United States
(12) Patent Application Publication
(10) Pub. No.: US 2005/0128150 A1
(43) Pub. Date: Jun. 16, 2005

(54) 3D measuring method & equipment for antenna of wireless communication product

(75) Inventor: I-Fong Chen, Tao-Yuan City (TW)

Correspondence Address: BRUCE H. TROXELL, SUITE 1404, 5205 LEESBURG PIKE, FALLS CHURCH, VA, 22041, US

(73) Assignee: Auden Techno Corp.

(21) Appl. No.: 10/732,267

(22) Filed: Dec. 11, 2003

(51) Int. Cl. H02K 23/60

(52) U.S. Cl. 343/702; 324/637; 343/703

(57) ABSTRACT

A 3D measuring method and an equipment for an antenna of a wireless communication product, the measuring method following steps: positioning an object to be tested on a turntable capable of rotating for 360°; and driving an antenna testing and receiving device to rotate about the turntable and the object to be tested thereon to obtain a 3D measuring field type.

### BACKGROUND OF THE INVENTION

1. Field of the Invention

The present invention is related to a 3D measuring method and an equipment for an antenna of a wireless communication product, and especially to 3D measuring of a wireless communication product with an economic equipment.

2. Description of the Prior Art

The industry of global communication equipments has grown stably in the recent years following rapid development of the market of electrical communication. According to statistics of Reed Electronics Research, the scale of the market of the global communication equipments in the year of 2001 has been reached to 291.80 billions USD. Reed Electronics Research estimated that the market of the global communication equipments in the year of 2004 will get close to 320.00 billions USD, and the amount of production of wireless communication will occupy 60% of the gross yield of the global communication equipments. In such a huge amount of wireless communication products, the safety of use and the performances of the products have been the key factors to determine whether they can be marketed; while the most important factor influencing the performances of the products is the types of field of antennas.

Development of antennas for wireless communication products (such as cell phones) is not subjected to influencing of electric circuit boards and bodies of users because of larger sizes of the antennas in the initial stage, thereby big cell phone factories all requested only to test 2D field types. While following miniaturization of cell phones, antennas also get smaller and smaller correspondingly, and the chance that they are influenced by electric circuit boards and bodies of users is relatively increased. Therefore, it has been a tendency nowadays that the antennas of wireless communication products are required to be of 3D field types; and the importance of 3D detecting equipments for antennas also has been increased.

Domestic and foreign 3D measuring equipments used presently mainly include two kinds, one of which is a French system (Satimo Spherical Near-field Antenna Measurement System), and the other kind is the U.S. ETS system.

The main test principle of the French Satimo system includes using 64 dual polarized measurement antennas forming a semi-circular array, a testing turntable is provided at the center of the circle; an antenna product to be tested is positioned at the center of the turntable, it is rotated for 360° to get information from the 64 dual polarized measurement antennas arranged at different angular positions, and a 3D measuring field type is obtained. This system has an advantage of immediate acquiring of the measuring result, and high accuracy of testing (<o.75 dB); but it has a defect of using a large amount of testing and receiving antennas, the entire equipment of it is very expensive and thereby does not meet the desire of the markets. Meantime, because of the array of the 64 dual polarized measurement antennas used is hard to correct, costs for maintenance of the equipment and correction are both high. And more, the array of the 64 dual polarized measurement antennas are disposed along the semi-circle alternately one at each 5° angular distance, the pending line at the center of the circle will have an error of 10°.

The main test principle of the U.S. ETS system includes using a clamping arm to rotate an object to be tested for 360°, and using a dual polarized antenna with slots to achieve the object of measuring, This system has an advantage of high accuracy of testing and easiness for correction; but it has a defect of having a slower speed and being unable to bear a product to be tested which is over 1 kg.

### SUMMARY OF THE INVENTION

The primary object of the present invention is to provide a 3D measuring method and an equipment for an antenna of a wireless communication product, it can perform 3D measuring of a wireless communication product with an economic equipment. To obtain the abovementioned object, the present invention includes the following steps:
positioning an object to be tested on a turntable capable of rotating for 360°; and
driving an antenna testing and receiving device to rotate about the turntable and the object to be tested thereon to obtain a 3D measuring field type.

In a preferred embodiment, the rotating angle of the turntable is −10°˜+370°, the rotating speed of the turntable is 1˜25°/sec.; the rotating angle of the antenna testing and receiving device is −140˜+165°, while the rotating speed of the device is 0.1˜5°/sec.

In a practical embodiment, the measuring method controls measuring with testing software which includes the functional blocks stated below:
driving a controller to make the turntable and the antenna testing and receiving device rotate and perform positioning, in order to obtain the rotating angle of the turntable and the rotating angle of the antenna testing and receiving device;
setting and picking up the values measured on a measuring instrument;
making operation and data conversion of the value of distance from the antenna testing and receiving device to the center of the turntable, the rotating angle of the turntable and the rotating angle of the antenna testing and receiving device, in order that the 3D array is converted to draw the distributing diagram of the 3D measuring field type and in order to output.

In a preferred embodiment, the 3D measuring equipment for an antenna of a wireless communication product of the present invention comprises:
a turntable capable of rotating for 360°, an object to be tested is positioned at the center of the turntable;
at least an antenna testing and receiving device able to be controlled to rotate about the turntable and the object to be tested thereon; and
a controller able to control the turntable and the antenna testing and receiving device.

In a practical embodiment, the controller to control the antenna testing and receiving device is a mechanical arm or an intermittent delivery device.

The present invention will be apparent in its novelty and other characteristics after reading the detailed description of the preferred embodiment thereof in reference to the accompanying drawings.

### BRIEF DESCRIPTION OF THE DRAWINGS

FIG. 1 is a schematic view of a practical embodiment of the present invention.

### DETAILED DESCRIPTION OF THE PREFERRED EMBODIMENT

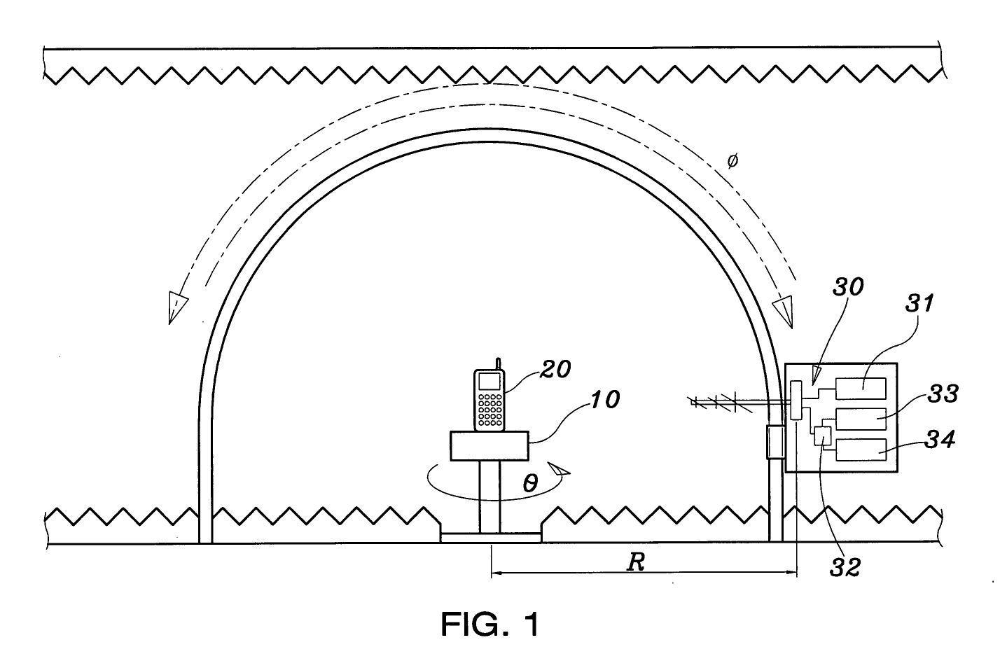

Referring firstly to FIG. 1, wherein the present invention comprises: a turntable 10 capable of rotating for 360°, an object 20 to be tested is positioned at the center of the turntable 10; at least an antenna testing and receiving device 30 able to be controlled to rotate about the turntable 10 and the object 20 to be tested.

In the practical embodiment, the height (including the electromagnetic wave absorbing substance) of the turntable 10 can be set as 2.45 m, it can be adjusted down for 10 cm; the diameter of the turntable 10 is set as circa 50 cm to afford bearing an object to be tested which is larger than 20 kg. The rotating angle θ of the turntable 10 is −10°˜+370°, the rotating speed of the turntable is 1˜25°/sec.

In the embodiment shown, the antenna testing and receiving device 30 is an HV antenna testing and receiving device; the H end is connected to a spectrum analyzer or measuring receiver 31, while the V end is connected to another spectrum analyzer or RF power splitter 32; the antenna testing and receiving device 30 further has a base station simulator 34. The antenna testing and receiving device 30 is only for the convenience of specification rather than giving any limitation to the present invention. In the practical embodiment, the rotating angle ( ) of the antenna testing and receiving device 30 is −140˜+165°, while the rotating speed of the device 30 is 0.1˜5°/sec. The distance from the antenna testing and receiving device 30 to the center of the turntable 10 can be 110˜150 cm.

The rotating and controlling device of the antenna testing and receiving device 30 can be a mechanical arm or an intermittent delivery device (not shown), so that the antenna testing and receiving device 30 can be mounted on such a device to perform an intermittent rotation in a set time (such as with the above stated rotating speed of 0.1˜5°/sec).

In this mode, the present invention obtain a desired 3D measuring field type by circulating rotation of the antenna testing and receiving device 30 and rotation under control of the turntable 10 and the object 20 to be tested. The testing software for measuring can be written with LabVIEW, and includes the functional blocks stated below:
driving a controller (not shown) to make the turntable 10 and the antenna testing and receiving device 30 rotate and perform positioning, in order to obtain the rotating angles θ and Φ for 3D drawing;
setting and picking up the values measured on a measuring instrument;
making operation and data conversion of the value of distance R from the antenna testing and receiving device 30 to the center of the turntable 10, the rotating angle θ of the turntable 10 and the rotating angle Φ of the antenna testing and receiving device 30 by taking advantage of the writing program, in order that the 3D array is converted to draw the distributing diagram of the 3D measuring field type and in order to output.

By the fact that the present invention can use only a single antenna testing and receiving device, it not only can largely reduce the cost of such a 3D measuring equipment to a degree that can be accepted by the markets, but also can have the advantage of getting inexpensive costs of maintenance and correction even when it is used to test a heavier product, and hence has a high value of industrial utility.

The embodiment disclosed above is only for illustrating and not for giving any limitation to the scope of the present invention. It will be apparent to those skilled in this art that various modifications or changes made without departing from the spirit and scope of this invention shall fall within the scope of the appended claims.

1. A 3D measuring method for an antenna of a wireless communication product, said measuring method includes the following steps: positioning an object to be tested at the center of a turntable adapted for rotating for 360°; and driving an antenna testing and receiving device to rotate about said turntable and said object to be tested thereon to obtain a 3D measuring field type.

2. The 3D measuring method for an antenna of a wireless communication product as defined in claim 1, wherein rotating angle of said turntable is −10°˜+370°, rotating speed of said turntable is 1˜25°/sec.

3. The 3D measuring method for an antenna of a wireless communication product as defined in claim 1, wherein rotating angle of said antenna testing and receiving device is −140˜+165°, while rotating speed of said antenna testing and receiving device is 0.1˜5°/sec.

4. The 3D measuring method for an antenna of a wireless communication product as defined in claim 1, wherein said measuring method controls measuring with testing software which includes functional blocks as stated below:
driving a controller to make said turntable and said antenna testing and receiving device rotate and perform positioning, in order to obtain a rotating angular value of said turntable and a rotating angular value of said antenna testing and receiving device for 3D drawing;
setting and picking up values measured on a measuring instrument;
3) making operation and data conversion of a value of distance R from said antenna testing and receiving device to said center of said turntable, said rotating angle of said turntable and said rotating angle of said antenna testing and receiving device, in order that a 3D array is converted to draw an distributing diagram of said 3D measuring field type and in order to output.

5. A 3D measuring equipment for an antenna of a wireless communication product, said measuring equipment comprises:
a turntable adapted for rotating for 360°, an object to be tested being positioned at the center of said turntable;
at least an antenna testing and receiving device able to be controlled to rotate about said turntable and said object to be tested thereon; and
a controller adapted for controlling said turntable and said antenna testing and receiving device.

6. The 3D measuring equipment for an antenna of a wireless communication product as defined in claim 1, wherein said controller to control said antenna testing and receiving device is a mechanical arm.

7. The 3D measuring equipment for an antenna of a wireless communication product as defined in claim 1, wherein said controller to control said antenna testing and receiving device is an intermittent delivery device.
